(19) United States
(12) Patent Application Publication
(10) Pub. No.: US 2026/0200347 A1
(43) Pub. Date: Jul. 16, 2026

(54) CONDUCTIVE CHARGING SYSTEM WITH PROTECTIVE CONDUCTOR AS CONTACT SURFACE, AND ELECTRIC VEHICLE COMPRISING CHARGING SYSTEM

(71) Applicant: Schaeffler Technologies AG & Co. KG, Herzogenaurach (DE)

(72) Inventors: Andreas Stuffer, Weingarten (DE); Marco Happe, Übach-Palenberg (DE); Philipp Maurer, Aachen (DE); Alexander Boxberger, Erkelenz (DE)

(73) Assignee: Schaeffler Technologies AG & Co. KG, Herzogenaurach (DE)

(21) Appl. No.: 19/137,642

(22) PCT Filed: Nov. 16, 2023
(86) PCT No.: PCT/DE2023/100885

§ 371 Date: Jun. 11, 2025

(30) Foreign Application Priority Data
Dec. 15, 2022 (DE) 10 2022 133 470.8

(51) Int. Cl. B60L 53/16; B60L 53/18; B60L 53/30; H01R 13/405; H01R 13/66

(52) U.S. Cl. CPC B60L 53/16; B60L 53/18; B60L 53/30; H01R 13/405; H01R 13/6658

(57) ABSTRACT

A conductive charging system for charging an electric vehicle includes an electrically conductive plate, electrically conductive contact pieces arranged for contacting mating contact pieces, and a protective conductor. The electrically conductive plate has a plurality of recesses and the electrically conductive contact pieces are inserted into the plurality of recesses. The protective conductor is electrically connected to the electrically conductive plate and arranged for contacting a mating protective conductor.

### CROSS-REFERENCE TO RELATED APPLICATIONS

This application is the United States National Phase of PCT Appln. No. PCT/DE 2023/100885 filed Nov. 16, 2023, which claims priority to German Application No. DE 102022133470.8 filed Dec. 15, 2022, the entire disclosures of which are incorporated by reference herein.

### TECHNICAL FIELD

The present disclosure relates to a conductive charging system for charging an electric vehicle, such as a passenger car, a commercial vehicle, for example a truck, or another land-based motor vehicle. The conductive charging system includes a plate which has a plurality of recesses into which electrically conductive contact pieces are inserted, which are provided for contacting mating contact pieces, and a protective conductor is present, which is provided for contacting at least one mating protective conductor.

### BACKGROUND

A contacting system for establishing an electrical connection between a primary device and a secondary device is already known from the prior art, such as EP 3 433 908 B1.

### SUMMARY

In the conductive charging system according to the disclosure, the plate is designed to be electrically conductive and is connected to the protective conductor in an electrically conductive manner.

In other words, the present disclosure relates to a base unit in which a perforated plate is used as a single PE contact, thus as a protective conductor, i.e., a grounding or protective contact, and the plate/perforated plate occupies a surface of a base part and has recesses for power and information contacts. The perforated plate is made of electrically conductive but non-magnetizable material, for example stainless steel. The perforated plate is connected to a protective conductor at at least one position. In an example embodiment, support elements transfer a load from a vehicle, etc., to an underside of the base unit particularly well.

It should be understood that when creating a conductive connection for the electrical charging of vehicles, for example, a protective (protective earth, PE) conductor should/must be contacted in a suitable manner. Ideally, this connection should be the first to be created and the last to be disconnected. With longitudinally pluggable contacts, this is done via leading contacts. In the case of flat-contacting contacts, this is done on the one hand via increased spring deflections of contacts, and on the other hand (with significant displacement) due to larger surface areas of the PE contacts compared to the power contacts.

Therefore, it is no longer necessary for the contacts to be permanently connected to a protective conductor, whereby other contacts are also connected to the protective conductor via switching devices in the normal state, but in the switched state these are connected to an electrical current path.

Therefore, it is no longer necessary to use a large number of individual contacts, which reduces assembly work and costs. Whereas previously a great deal of space was needed for contacting the protective conductor, space is now created below the surface. In addition, the penetrations are reduced. Many penetrations of the contacts through a housing surface always harbors the risk of potential leaks. This is now ruled out. Sensitive insulating material, which previously surrounded the contacts and comprised plastic, for example, can be avoided, particularly in the case of casting. A larger active protective conductor area is now available.

An example embodiment includes replacing the individual PE contacts with a perforated sheet which now occupies the surface of the floor part and has recesses for the power and information contacts. The perforated plate is made of electrically conductive but non-magnetizable material, for example stainless steel. The perforated plate is connected to the protective conductor at at least one position. As contacting is no longer required, support elements can now be used instead of the previous PE pin contacts, which can transfer loads from vehicles, etc., to the underside of the floor unit particularly well. This reduces the assembly effort and costs involved.

Such conductive charging systems are units that can be recessed in the floor or attached to the floor, including a base unit with said plate. If a car drives over this charging system, either a contacting part attached to the vehicle can lower onto the charging system or a corresponding contacting part can move from the charging system towards the vehicle. Such a lowering or lifting movement can be automated. This enables automated charging.

In detail, the surface of the plate can be designed as a protective conductor surface with recesses for the power contacts and other control contacts. Power contacts that are embedded/molded into the surface can be separated from the PE contact surface with insulating material. Power contacts can be connected to a printed circuit board, for example. Support elements/supporting elements can be made of a ferrous material, for example, so that an external magnet can interact therewith. If the support elements are not required for structural reasons, flatter implementations can also be used so that the magnetic force can be absorbed effectively. Such implementations are understood to be plates.

In a base unit, a perforated plate is used as a single PE contact, i.e., a grounding or protective contact, which occupies one surface of a base part and has recesses for power and information contacts. The perforated plate is made of electrically conductive but non-magnetizable material, for example stainless steel. The perforated plate is connected to a protective conductor at at least one position. Protective elements/pillars transfer a load from a vehicle, etc., to the underside of the floor unit/base unit particularly well.

In an example embodiment, an electrical insulation is present between the contact pieces and the plate and/or a seal is present between the contact pieces and the plate. In this way, unwanted fault currents and/or corrosion damage can be avoided. The result here is greater and better durability.

It has proven successful when the insulation represents the seal and vice versa. If the insulation forms the seal or is designed in such a way that it acts as a seal against dirt, moisture, and the like, this provides special advantages.

If the plate is made of a metallic and/or non-magnetizable material or is at least partially made thereof, a particularly robust design can be achieved that is not susceptible to external influences.

It is expedient for the plate to be made of stainless steel or possibly plastic, as this makes it possible to achieve a particularly aesthetically pleasing appearance or reduce costs. This also makes them easy to clean.

In an example embodiment, the contact pieces may be cast or embedded in the plate with the respective insulation/seal. The result is a particularly durable and resilient embodiment.

To prevent sagging, in particular bending and curvature, when a load is applied, support elements for the plate may be arranged/provided adjacent to the contact pieces, for example between or next to the contact pieces.

If the support elements are designed as pillars, beams, sleeves, pins or struts, it is particularly easy to implement options that ensure force transmission. Of course, it is possible to combine the different support elements with each other, so that different types of support elements are used. This can result in advantages in terms of installation space.

It has proven useful if the support elements are designed as separate components from the plate and the contact pieces, e.g., made of plastic or a ferrous material. As already mentioned, the use of ferrous materials is desirable.

An entire surface may only be contacted with the PE conductor at one point (instead of at each PE pin) and, in addition, the contact at previous PE pin points may be omitted and/or used for support elements or other components.

If the contact pieces are designed as power and/or control contacts, automated charging can be implemented particularly easily.

The present disclosure also relates to an electric vehicle which is connected to a conductive charging system according to the disclosure. The electric vehicle has mating contact pieces which are electrically connected to the contact pieces of the conductive charging system and a charging process then occurs during operation.

### BRIEF DESCRIPTION OF THE DRAWINGS

The present disclosure is also explained in more detail below with the aid of a drawing.

### In the Drawings:

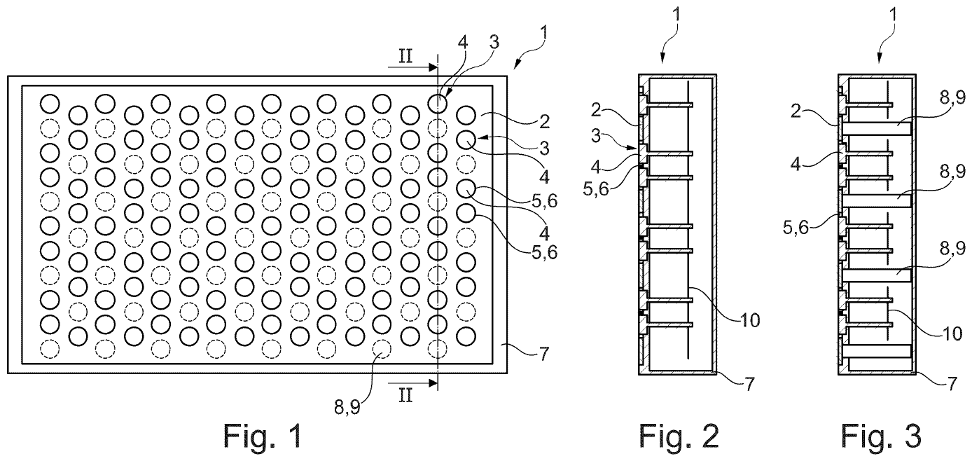

FIG. 1 shows a first embodiment of a conductive charging system according to the disclosure in a top view, whereby a floor unit with a protective PE conductor plate including a hole pattern/apertures for the electrical contact surfaces is used, and individual insulations are present around the contacts, whereby supports/support elements/supporting elements are used under the PE plate, which can optionally be activated with magnetic force,

FIG. 2 shows a cross-section through the charging system of FIG. 1, as part of a floor unit of an automated charging station in cross-section along line II from FIG. 1, and

FIG. 3 shows the cross-section from FIG. 2 with support elements completing the structure.

### DETAILED DESCRIPTION

The figures are only schematic in nature and serve only for understanding of the disclosure. Identical elements are provided with the same reference symbols.

A conductive charging system 1 is shown in FIG. 1. It is intended for installation in the floor or on the floor. It is thus a floor unit. It has a plate 2. The plate 2 contains a plurality of recesses 3. The recesses 3 are provided to accommodate contact pieces 4. The contact pieces 4 are in turn surrounded by a seal 5 or an insulation/electrical insulator 6. In the present embodiment, a single component forms both the seal 5 and the insulation 6.

The plate 2 sits in a housing 7 of the floor unit.

As can be seen in FIGS. 1 through 3, the contact pieces 4 are evenly distributed. The reinforcement of the charging system 1 is completed by the use of support elements 8, as shown in FIG. 3. Support elements 8, which are designed as pillars 9, sit in the housing 7 and support the plate 2 from below. They are therefore in direct contact with the plate 2.

The contact pieces 4, as can be readily seen in FIGS. 2 and 3, are in electrically conductive contact with a printed circuit board 10.

Neither the protective conductor, nor the mating contact pieces, nor the mating protective conductor are shown in the figures.

### REFERENCE NUMERALS

1 Charging system
2 Plate
3 Recess
4 Contact piece
5 Seal
6 Insulation/electrical insulator
7 Housing
8 Support element
9 Pillar
10 Printed circuit board

1. A conductive charging system for charging an electric vehicle, comprising a plate which has a plurality of recesses into which electrically conductive contact pieces are inserted, which are provided for contacting mating contact pieces, wherein:
a protective conductor is present, which is provided for contacting at least one mating protective conductor, and
the plate is designed to be electrically conductive and is connected to the protective conductor in an electrically conductive manner.

2. The charging system according to claim 1, wherein:
an electrical insulation is present between the contact pieces and the plate; or
a seal is present between the contact pieces and the plate.

3. The charging system according to claim 2, wherein the insulation represents the seal.

4. The charging system according to claim 1, wherein the plate consists of an electrically conductive metallic or electrically conductive non-magnetizable material.

5. The charging system according to claim 1, wherein the plate consists of stainless steel.

6. The charging system according to claim 1, wherein the contact pieces are cast or embedded in the plate.

7. The charging system according to claim 1, wherein support elements for the plate are provided adjacent to the contact pieces.

8. The charging system according to claim 7, wherein the support elements are designed as pillars, beams, sleeves, pins, or struts.

9. The charging system according to claim 1, wherein the contact pieces are designed as power contacts or control contacts.

10. An electric vehicle which is connected to the conductive charging system according to claim 1, wherein the electric vehicle has mating contact pieces which are electrically connected to the contact pieces of the conductive charging system and a charging process thus occurs during operation.

11. A conductive charging system for charging an electric vehicle comprising:
an electrically conductive plate comprising a plurality of recesses;
electrically conductive contact pieces inserted into the plurality of recess and arranged for contacting mating contact pieces; and
a protective conductor, electrically connected to the electrically conductive plate and arranged for contacting a mating protective conductor.

12. The conductive charging system of claim 11, further comprising an electrical insulation arranged between the electrically conductive contact pieces and the electrically conductive plate.

13. The conductive charging system of claim 12, wherein the electrical insulation is a seal.

14. The conductive charging system of claim 11, wherein the electrically conductive plate is formed from a metallic or a non-magnetizable material.

15. The conductive charging system of claim 11, wherein the electrically conductive plate is formed from stainless steel.

16. The conductive charging system of claim 11, wherein the contact pieces are cast or embedded in the electrically conductive plate.

17. The conductive charging system of claim 11, further comprising plate support elements arranged adjacent to the contact pieces.

18. The conductive charging system of claim 17 wherein the plate support elements are pillars, beams, sleeves, pins or struts.

19. The conductive charging system of claim 11, wherein the contact pieces are power contacts or control contacts.
